(19) United States
(12) Patent Application Publication
(10) Pub. No.: US 2012/0256840 A1
(43) Pub. Date: Oct. 11, 2012

(54) VIRTUAL KEYBOARD

(76) Inventor: Mahmoud Razzaghi, Chula Vista, CA (US)

(21) Appl. No.: 13/083,575

(22) Filed: Apr. 10, 2011

(51) Int. Cl. G06F 3/02

(52) U.S. Cl. 345/168

(57) ABSTRACT

A touch screen virtual keyboard is disclosed that allows selecting and entering any key without blocking its view by the user's finger. A touch screen in a computer or cell phone has a virtual keyboard and a text box. To enter a desired key into the text box, the user focuses on the desired key and taps the area below that key. The position of the finger is mapped to address and select the key immediately above the finger. Additional finger tap space is provided at the bottom of the virtual keyboard for selecting and entering the keys in the bottom row. In a similar embodiment, each key is extended vertically. The key character is displayed on the upper portion of the key. To select and enter a desired key into the text box, the user taps the blank lower portion of the key below the desired key character. In another similar embodiment, there is a blank row under each row of keys for addressing the keys above the blank row. To select and enter a desired key into the text box, the user taps the lower blank row below the desired key.

### FIELD OF THE INVENTION

This invention relates to touch screen text input and virtual keyboards for computers, cell phones, and electronic devices.

### BACKGROUND OF THE INVENTION

In touch screen computer interface, text is inputted through a virtual keyboard displayed on the screen. Keys are generally touched by finger or a stylus to enter text.

In the relatively small cell phone virtual keyboard, as the finger approaches a desired key, it blocks the view of the desired key and other adjacent keys, which interrupts the feedback required for proper positioning of the finger. This causes confusion and user discomfort resulting in slow typing speed and increased typing error.

As a solution to this problem, a pop up key shows the selected key. However, the user needs to do the extra task of looking away from the location of the finger to see the pop up key. Also, to navigate to the desired key, the user must move finger in a trial and error form. These two extra tasks for every key input substantially reduce typing speed.

Many users directly aim and tap in an effort to enter the desired key in one movement and without attention to the pop up feedback. This increases typing speed but at the same time increases typing error.

Also, the minimum key size requirement in relation to finger size limits the number of keys. Therefore, numeric and punctuation keys are provided in a separate keyboard. The user must toggle between the two keyboards which reduces typing speed.

Some virtual keyboards use one key to input multiple characters. However, the arrangement requires special attention and longer touch time to select the additional characters. Besides, due to lack of space, the size of characters displayed on the keys becomes too small for easy viewing.

In larger touch screens, the virtual keyboard can have large keys, but this will require large movements of the arm and hand, which substantially reduces typing speed.

### OBJECTS OF THE INVENTION

Therefore, the object of the invention is to provide a touch screen virtual keyboard with the following improvements:
1. Provide direct view of the desired key during typing with small virtual keyboards.
2. Provide additional space for individual numeric or punctuation keys on same virtual keyboards without compromising the space for finger touch.
3. Increase typing speed and accuracy.

### DESCRIPTION OF THE DRAWINGS

FIG. 1 shows the first embodiment of the invention.

FIG. 2 shows the second embodiment of the invention.

FIG. 3 shows the third embodiment of the invention.

### BRIEF DESCRIPTION OF THE INVENTION

A touch screen virtual keyboard is disclosed that allows selecting and entering any key without blocking its view by the user's finger.

A touch screen in a computer or cell phone has a virtual keyboard and a text box. To enter a desired key into the text box, the user focuses on the desired key and taps the area below that key. The position of the finger is mapped to only address and select the key immediately above the finger. Additional finger tap space is provided at the bottom of the virtual keyboard for selecting and entering the keys in the bottom row.

In a similar embodiment, each key is extended vertically. The key character is displayed on the upper portion of the key. To select and enter a desired key into the text box, the user taps the blank lower portion of the key below the desired key character.

In another similar embodiment, there is a blank row under each row of keys for addressing the keys above the blank row. To select and enter a desired key into the text box, the user taps the lower blank row below the desired key.

### DETAILED DESCRIPTION OF THE INVENTION

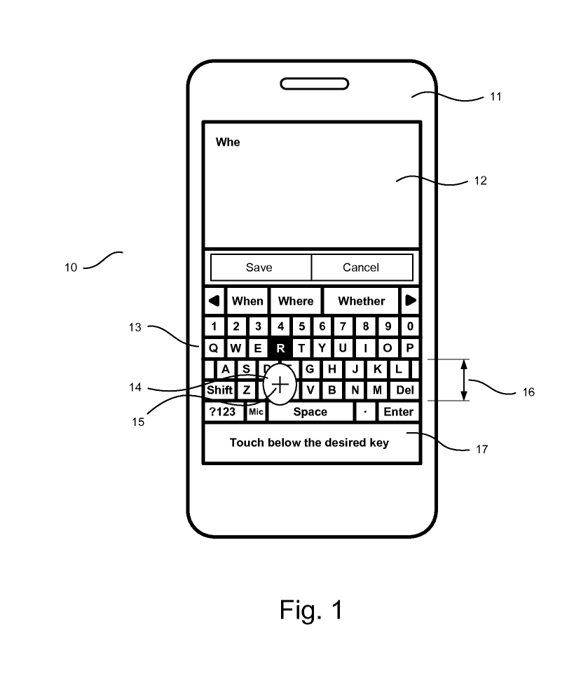

According to the first preferred embodiment of the invention, FIG. 1, there is a cell phone 10 with touch screen 11. A text box 12 at the top of touch screen 11 shows the text entered by the user. A virtual keyboard 13 is displayed below text box 12.

To select and enter a desired key, such as R key, into the text box, the user focuses on the desired key and touches the area below that key. The desired key changes visually to show the selection of the key. Then, the user lifts the finger and the selected key is entered into the text box.

Although the user touches other keys below the desired key, the registered position of the finger is mapped to only address and select the key immediately above the finger. The fingerprint 14 with its position coordinate mark 15 shows an instance of selecting the R key. Any position of the finger with a coordinate within the width of the R key and the height range 16 would select the same R key.

Thus, there is sufficient margin for vertical positioning of the finger. With uninterrupted view of the desired key, both horizontal and vertical positioning of the finger are naturally easy and accurate. The user can generally hit the correct location for a desired key in the first touch without the need to adjust finger position. As a result, accurate typing can be performed at a higher speed compared to using a conventional virtual keyboard.

There is a blank row 17 at the bottom of the virtual keyboard to touch and select the keys in the bottom row.

Since the user focuses on the desired key, other keys below it would not interfere visually with the positioning of the finger.

The first embodiment of the invention allows inclusion of extra rows of keys such as numeric keys in a cell phone without requiring extra space or compromising comfort and accuracy of typing.

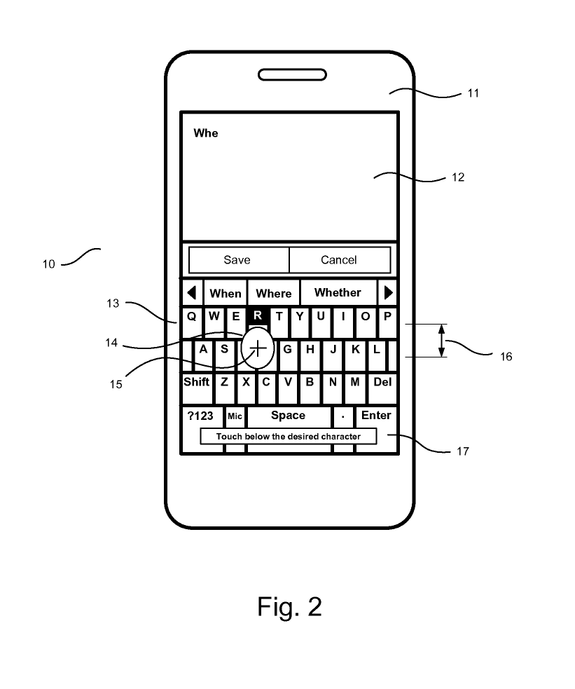

In the second embodiment of the invention, FIG. 2, there is a cell phone 10 with touch screen 11. A text box 12 at the top of touch screen 11 shows the text entered by the user. A virtual keyboard 13 is displayed below text box 12.

Each key image is extended vertically. The respective character is displayed on the upper portion of each key. To select and enter a desired key, such as R key, into the text box, the user touches the blank lower portion of the key. The key changes visually to confirm selection. The user lifts the finger to enter the key in the text box.

To provide sufficient space for vertical positioning of the finger, the upper portion of each row of keys is included in the touch zone of the finger for the keys in the upper row. The fingerprint 14 with its position coordinate mark 15 shows an instance of selecting the R key. Any position of the finger with a coordinate within the width of the R key and the height range 16 would select the same R key.

The keys of the bottom row of the virtual keyboard 13 have longer vertical extension to give them same touch space as the upper rows.

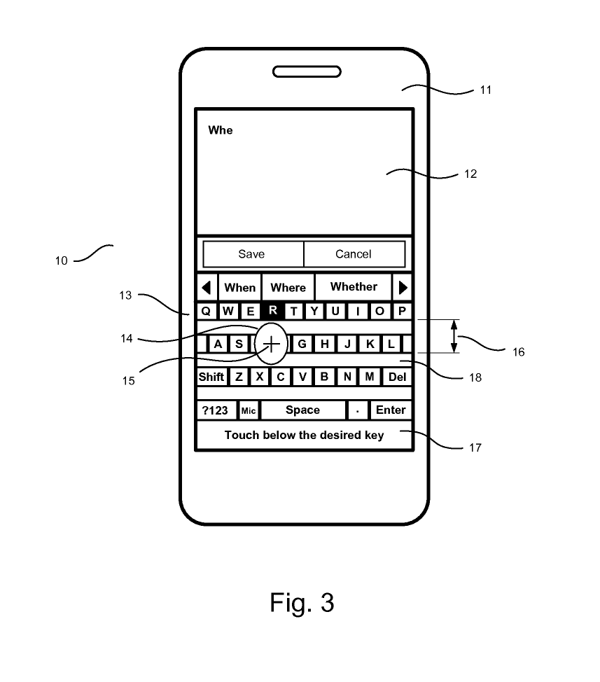

In the third embodiment of the invention, FIG. 3, there is a cell phone 10 with touch screen 11. A text box 12 at the top of touch screen 11 shows the text entered by the user. A virtual keyboard 13 is displayed below text box 12. There is a blank row 18 under each row of keys for addressing the keys above the blank row.

To select and enter a desired key, such as the R key, into the text box, the user touches the lower blank row 18 below the desired key. The key changes visually to show the selection. Then, the user lifts the finger and the selected key is entered in the text box.

Although the user may touch other keys below the blank row, the position of the finger is mapped to only address and select the key immediately above the finger. The fingerprint 14 with its position coordinate mark 15 shows an instance of selecting the R key. Any position of the finger with a coordinate within the width of the R key and the height range 16 would select the same R key.

The small virtual keyboard of the invention can be used in larger touch screens to reduce hand movement and increase typing speed.

I claim:

1. A touch screen keyboard system for text input in cell phones, computers, and electronic devices, comprising:
a touch screen integrated with a cell phone or computer,
the touch screen has a virtual keyboard,
an area adjacent to and below the character displayed on each key of the virtual keyboard is mapped to address the respective key,
the user touches the area adjacent to and below the character displayed on a desired key to select that key, and then removes the finger to input that key.

2. The keyboard system of claim 1 further having a text box, to display the inputted character.

3. The keyboard system of claim 1 wherein the selected key changes visually as a feedback to the user.

4. The keyboard system of claim 1 having additional space below the bottom row of the keyboard for addressing the keys of the bottom row.

5. The keyboard system of claim 1 wherein each key character is displayed on the upper portion of the respective key, the lower portion of the respective key provides target touch location mapped for addressing the respective key.

6. The keyboard system of claim 5 wherein the mapped area for addressing each key additionally includes the upper portion of adjacent lower key or keys.

7. The keyboard system of claim 1 having a blank area below each key to provide target touch location mapped for addressing the respective key.

8. The keyboard system of claim 7 wherein the mapped area for addressing each key additionally includes the upper portion of adjacent lower key or keys.

9. A touch screen keyboard system for text input in cell phones, computers, and electronic devices, comprising:
a touch screen integrated with a cell phone or computer,
the touch screen has a virtual keyboard
the character for each key is displayed on the upper part of the respective key,
the blank lower part of each key is mapped to address the respective key,
the user touches the blank part below the character displayed on a desired key to select that key, and then removes the finger to input that character,
thus, providing uninterrupted view of the desired character during typing.

10. The keyboard system of claim 9 wherein the mapped area for addressing each key additionally includes the upper portion of adjacent lower key or keys.
